(19) United States
(12) Patent Application Publication
(10) Pub. No.: US 2002/0121631 A1
(43) Pub. Date: Sep. 5, 2002

(54) Radiation curable coatings for printed surfaces

(76) Inventors: Ata Rahman, Bernville, PA (US); Keri Tarantino, Perrineville, NJ (US)

Correspondence Address: Hugh A. Abrams, Sidley Austin Brown & Wood, Bank One Plaza, 10 S. Dearborn Street, Chicago, IL, 60603, US

(21) Appl. No.: 10/001,587

(22) Filed: Oct. 31, 2001

Related U.S. Application Data
(60) Provisional application No. 60/244,450, filed on Oct. 31, 2000.

(51) Int. Cl. H01B 1/00

(52) U.S. Cl. 252/500

(57) ABSTRACT

A radiation curable coating composition includes one or more reactive monomers; a surface curing photoinitiator; an amine synergist; one or more reactive oligomeric resins; a through-cure photoinitiator; and an aqueous polymer emulsion. The composition provides an overprint varnish that can be applied in-line over a conventional lithographic ink.

This application claims the benefit of U.S. Provisional Application Serial No. 60/244,450, filed Oct. 31, 2000.

### BACKGROUND OF THE INVENTION

Clear radiation-cured (such as ultraviolet light radiation and electron beam radiation, for example) coatings are used as overprint varnishes to impart a glossy appearance and excellent abrasion resistance to printed paper and board (e.g., magazine and book covers, post cards, record jackets, and labels). The use of gloss coatings on these substrates has evolved over the past thirty years, and radiation-cured coatings have steadily replaced the conventional solvent-based coatings. In the following discussion, the term “UV” is intended to generally include various types of radiation curable coatings, such as visible light and electron beam, and the like.

Radiation-cured technology has developed rapidly since these inks and coatings were introduced in the early 1970s, and much effort has been expended to develop oligomers and monomers with lower odor, better viscosities, better color, and less potential for skin irritation. However, certain problems still need to be solved. There is one primary problem in the overprinting of offset lithographic inks with radiation-cured overprint varnishes: the gloss and adhesion of the overprint varnish films are poorer when applied and cured over incompletely cured offset lithographic ink films.

Most magazine and book covers, post cards, record jackets and labels are printed by sheet-fed offset lithography using air-drying inks. Electron beam (EB) radiation cured coatings are not popular for this application as it is difficult to keep the curing chamber free of oxygen in a sheet-fed operation. EB coatings are generally used for web offset applications. These inks, which cure slowly upon exposure to atmospheric oxygen, must be completely cured before the ultraviolet light-cured overprint varnish is applied and cured; otherwise, the overprint varnish shows poor gloss and adhesion. The lithographic inks take up to 20 hours to cure. Therefore, the recommended elapse time between printing of the lithographic inks and the application and curing of the overprint varnish is 24-48 hours. If the overprint varnish could be applied and cured on the incompletely cured lithographic ink film without loss in gloss and adhesion, the savings in time and effort would be considerable.

Thus far, there are only two ways to reduce the time between the printing of the conventional sheet-fed lithographic ink and the application and curing of the overprinting varnish. One method is to apply an intermediate coating of a water-based acrylic resin, which acts as an “anchor” coating to improve the gloss and adhesion of the overprint varnish to the air-drying ink film. The other technique is to use UV curable lithographic inks for printing instead of the conventional air-dry lithographic inks.

In the case of water-based primer, the overprint varnish can be applied within a few hours after drying the water-based coating without loss of adhesion or gloss. However, the water-based coating requires the addition of a separate coating station, which most printers and converters are reluctant to install. This technique requires off-line coating of the UV varnish and cannot be done in-line over partially dried water-based primer and fresh lithographic inks.

Moreover, the economics are poor. The 30-35% solids water-based coating is used in a concentration of 2.5-3.0 lbs./3000 ft². The cost of the water-based coating is about $1.20/lb.; that of the UV varnish is about $3.50/lb. The amount of water-based coating required is almost as great as that of the UV overprint varnish, which amounts to a 30% increase in raw material cost plus the extra cost of storage and handling to maintain an inventory of this raw material.

Taking all of these factors into account, the total cost of using the water-based coating plus the overprint varnish would be 30-40% more than the cost of using the overprint varnish alone. Printers could reduce their total cost by 30% to 40% if there was an overprint varnish that retained its gloss and adhesion when applied and cured over incompletely cured sheetfed lithographic inks.

In the case of UV curable lithographic inks, the UV varnish can be applied directly in-line over freshly printed inks. The inks dry instantaneously upon exposure to UV light in between color stations and, therefore, the UV overprint varnish can be applied in-line directly over these inks. There is, however, considerable cost involved in this process. UV lithographic inks are 2.5 to 3 times as expensive as conventional air-dry inks. The color strength of UV lithographic inks is generally not as good as that of conventional lithographic inks due to the inability of UV resins to wet out pigments as readily as conventional varnishes leading to relatively low pigment loading. Also, higher loading of pigments reduces the cure speed of UV curable inks requiring higher quantities of photoinitiator which leads to increased ink cost. Lower pigment loadings require more ink to reach the same color strength, which results in poor ink mileage and extra cost. The UV curing of these inks also requires a UV lamp between each print station that needs to be replaced every 1000 to 1500 hours, significantly increasing the cost as compared to air drying inks.

A second important concern to many customers is their interest in using porous, non-coated (non-clay coated) paper and board stock because of the lower cost of such stock. Paper cost is generally the major cost in a packaging construction. Conventional UV/EB coatings absorb in porous stock leading to: (i) poor gloss; (ii) poor scuff resistance; and (iii) odor—because the coating absorbed in the paper/board will not cure as the UV light cannot reach the coating.

There are currently two ways to reduce the absorption of a conventional UV coating into a porous stock. One is to increase the viscosity of UV coating to 1000 cps or higher. A second is to apply a water-based primer onto the surface of the porous stock to seal the surface and then to apply a UV/EB coating on top of the dried water-based coating.

Increasing the viscosity of the UV/EB coating creates other problems. For example, most coating application equipment is designed to run at around 100 cps (Gravure) or 400 cps (Flexo). It is difficult to apply a uniform coating thickness as the viscosity fluctuations in a high viscosity coating are significantly greater with small changes in temperature compared to a relatively lower viscosity UV/EB coating. Additionally, higher viscosity UV coatings require more time to flow and level and it is, therefore, more difficult to get a smooth glossy finish. Finally, the higher viscosity of UV/EB coatings leads to slinging and misting of the coating, which could be hazardous to the workers operating the press and can cause defects in the printed products.

Application of water-based primer, on the other hand, leads to several concerns which were discussed above including: (i) an additional coating station is needed; (ii) poor economics—cost of using a water-based primer could be 30% to 40% more than using the UV/EB coating alone; (iii) extra cost of thermally drying the water-based coating—the cost of thermally drying water-based coating is more than the cost of drying radiation curable coatings; (iv) clean-up of water-based coatings requires more time and involves a lot of waste generation as water-based coating will dry in the pan, on the rolls and in the pump and lines; (v) storage, handling and maintenance of inventory; and (vi) water-based coatings are generally not VOC free.

An additional concern is the performance of controlled slip UV/EB coatings over inks that include low surface energy additives. Controlled slip UV/EB coatings are presently used for applications such as multiwall bags for packing pet food, folding cartons, beverage suitcases, etc. Conventional UV/EB coatings require that the inks be free of any low surface energy materials like waxes, silicones, surface active agents (flow additives), Teflon®, silicas, and white pigments. Presence of low surface energy additives interferes with the surface coefficient of friction (“COF”) of conventional UV/EB coatings and generally reduces the COF.

Some flow additives that interfere with the COF of UV/EB coatings can be removed from the ink formulations, but then use of expensive resins is required to achieve flow and leveling of inks. Ink manufacturers cannot use recycled inks as they do not know what may be included in the ink (waxes, silicones, etc.). Use of virgin inks increases the overall cost. Some colors are difficult to match without opaque white extender pigments, which interfere with UV coatings in terms of achieving a high coefficient of friction.

COF on incompatible inks (containing low surface energy ingredients) can be increased but it leads to face-to-face blocking of the UV coating. Also, the COF of such a UV coating on compatible inks is too high, leading to problems at bag making plants.

The principal way to achieve consistent COF on inks containing low energy additives is to use water-based coatings. Problems with water-based coatings were discussed above and include: low gloss, poor scuff resistance, face-to-face blocking, and not VOC free (i.e., free of volatile organic compounds).

A fourth problem encountered with UV/EB coatings is that the surface energy of UV/EB coatings is generally low (examples are coatings for folding cartons, pet food bags, etc.). Surface energy of controlled slip UV/EB coatings is often too low for gluability. These coatings do not accept most adhesives. Printers leave open areas on the print to avoid gluing problems. In some cases (particularly when the coating is applied by a Gravure printing process), trace amounts of UV coating can be transferred to the areas meant for gluing. This results in problems at the final customer (pet food manufacturers, etc.) where the glued and sealed surfaces pop open.

### SUMMARY OF THE INVENTION

The present invention provides a series of UV/EB overprint varnishes that offer a solution to the problems mentioned above. In one embodiment, the present invention provides a radiation curable coating composition that includes: at least one reactive monomer in an amount of 20% to 60% wt.; at least one reactive oligomeric resin in an amount of 20% to 50% wt.; a surface curing photoinitiator in an amount of 5% to 10% wt.; an amine synergist in an amount of 5% to 15% wt.; a ketone photoinitiator in an amount of up to 10% wt.; and an aqueous polymer emulsion in an amount of at least 20% wt.

The present invention provides overprint varnishes (“OPV”) that can be applied in-line over conventional lithographic inks. The gloss of the UV/EB coatings over the undried conventional lithographic inks is in the same range as regular UV/EB OPV over air dried (48 hours aged) conventional lithographics inks. The OPV does not lose its gloss or adhesion to conventional inks upon aging. The present invention thus presents a solution to reducing the time lag between the printing and UV/EB coating in an off-line process. It also eliminates the need for an off-line coater. UV curing lamps can be installed on the printing press used to print conventional sheet-fed lithographic inks. Printers who are subcontracting UV coating jobs to custom coaters will be able to coat UV coatings in-line over conventional lithographic inks without using a water-based primer, thereby reducing costs. Job turn-around time will be reduced from one week to a few minutes and will be very cost effective. Printers will not have to deal with the transportation and process costs of custom coaters to finish the print order.

The present invention provides holdout on porous stock without excessively increasing the viscosity of the coating and eliminates the need for a water-based primer. Since the cost of porous (non-clay coated) paper is lower, this will result in significant savings for printers.

The present invention will allow the printers to achieve the COF of UV/EB coatings on water-based and solvent based inks without requiring them to eliminate all the low surface energy additives and white pigments. Printers will be able to use most of the recycled inks that they use for water-based coatings and will not have to maintain two inventories of inks. The use of this product will bring down the ink cost significantly.

Printers will be able to apply UV coatings over the entire surface, if needed, without having to leave open areas for gluing. Coating machines, like Steineman, etc., that can only flood coat a substrate, will be able to coat jobs that require spot coating because of the gluing problems. Gravure printers will be able to use just one roller for flood coating on every job. Presently, a different roller costing about $1500 is needed for each job.

### DETAILED DESCRIPTION OF THE PREFERRED EMBODIMENTS

All the additives for the varnishes of the present invention are commercially available and are made by several companies including Cognis, UCB, Rad cure, Sartomer, BASF, Rohm & Haas, and others.

The varnishes of the present invention generally include the following components: difunctional acrylate monomer and trifunctional acrylate monomer; benzophenone or a photoinitiator; amine synergist; ketone photoinitiator; siloxane polymer; acrylated oligomer; and acrylic polymer emulsion.

Acrylate and epoxy and polyurethane monomers include mono-, di-, tri-, and multi-functional monomers. These are used to adjust the viscosity, cure speed and control the degree of cross-linking. Difunctional acrylate monomer is commercially available as: (1) Cognus Photomer 4061; (2) Sartomer SR, and (3) UCM Radcure TRPGDA. Trifunctional acrylate monomer is commercially available as: (1) Cognus Photomer 4006; (2) Sartomer SR 351 : and (3) UCB Radcure TMPTA.

Some materials which are commonly used as monomers include:

(1) mono-functional monomers such as: alkyl methacrylate, tetrahydrofufuryl methacrylate, isodecyl methacrylate, 2(2-ethoxyethoxy) ethylacrylate, stearyl acrylate, tetrahydrofurfuryl acrylate, lauryl methacrylate, stearyl methacrylate, lauryl acrylate, 2-phenoxyethyl acrylate, 2-phenoxyethyl methacrylate, glycidyl methacrylate, isodecyl acrylate, isobornyl methacrylate, isooctyl acrylate, tridecyl acrylate, tridecyl methacrylate, caparolactone acrylate, ethoxylated nonyl phenol acrylate, isobornyl acrylate, polypropylene glycol monomethacrylate, lauryl methacrylate, stearyl methacrylate, lauryl acrylate, stearyl acrylate, hexadecyl acrylate, monomethoxy tripropylene glycol monoacrylate, monomethoxy neopentyl glycol propoxylate monoacrylate, B-carboxyethyl acrylate, and oxyethylated phenol acrylate;

(2) di-functional monomers, such as: triethylene glycol dimethacrylate, ethylene glycol dimethacrylate, tetraethylene glycol dimethacrylate, polyethylene glycol dimethacrylate, 1,3 butylene glycol diacrylate, 1,4 butanediol diacrylate, 1,4 butanediol dimethacrylate, diethylene glycol diacrylate, diethylene glycol dimethacrylate, 1,6 hexanediol diacrylate, 1,6 hexanediol dimethacrylate, neopentyl glycol diacrylate, neopentyl glycol dimethacrylate, polyethylene glycol dimethacrylate, polyethylene glycol diacrylate, tetraethylene glycol diacrylate, triethylene glycol diacrylate, 1,3 butylene glycol dimethacrylate, tripopylene glycol diacrylate, polyethylene glycol diacrylate, ethoxylated bisphenol A dimethacrylate, ethoxylated bisphenol A diacrylate, propoxylated neopentyl glycol diacrylate, ethoxylated neopentyl glycol diacrylate, ethoxylated tripopylene glycol diacrylate, monomethoxy trimethylolpropane ethoxylate diacrylate;

(3) tri-functional monomers, such as: tris (2-hydroxy ethyl) isocyanurate trimethacrylate, trimethylol propane triacrylate, trimethylol propane trimethacrylate, tris (2-hydroxy ethyl) isocyanurate triacrylate, ethoxylated trimethylol propane triacrylate, propoxylated glyceryl triacrylate ditrimethylol propane triacrylate, pentaerythritol triacrylate, and propoxylated trimethylolpropane triacrylate; and, (4) multi-functional monomers, such as: pentaerythritol tetraacrylate, di-trimethylol propane tetraacrylate, dipentaerythritol pentaacrylate, ethoxylated pentaerythritol tetraacrylate, and pentaacrylate ester.

The possible monomers to choose from are not limited by this list and others may be known to one skilled in the art or may become commercially available.

UV curable materials contain photoinitiator which absorb the UV light and starts the curing process. There are usually two types of photoinitiators used. One photoinitiator is for surface cure to overcome atmospheric oxygen inhibition and the other photoinitiator is used to assist in deep or through cure. For surface cure, there are several materials available. The most common type is benzophenone and related compounds, such as, methyl benzophenone, trimethylbenzophenone, and acrylated derivatives of benzophenone.

Benzophenone type initiators are effective only in the presence of an amine. The amine synergists are known to those skilled in the art and include but are not limited to the following: Aliphatic and aromatic, primary, secondary and tertiary amines, e.g. methyldiethanolamine, triethanolamine, triethylamine, aminobenzoates, alkylanilines, and acrylated amines, e.g., Ebecryl P104, Ebecryl P115, Ebecryl 7100 (UCB Radcure); Photomer 4967, Photomer 4770 (Cognis Corp.); CN 383 and CN 384 (Sartomer); and Laromer LR 8956 (BASF).

These amines are considered co-initiators with benzophenone. Benzophenone mostly helps cure the surface of a UV coating. All free radical UV coatings are inhibited by oxygen in the air. Benzophenone-amine combination takes care of the oxygen inhibition and, therefore, is a very effective photoinitiator for surface curing.

Through-cure photoinitiators are often ketone photoinitiators, including but not limited to alpha-hydroxyketones, alpha-amino-ketones, benzildimethyl-ketal, etc. and their blends. They do have some potential for surface cure but generally they are added for through-cure in combination with benzophenone/amine type photoinitiator systems. Ketone photoinitiators are also added to cross-link the reactive polymer emulsion (described below) which does not cure with benzophenone/amine chemistry. Some phosphine oxides are also used as through cure photoinitiators. The through cure photoinitiators are selected from acetophenones and ketals, benzophenones, aryl glyoxalates, acylphosphine oxides, sulfonium and iodonium salts, diazonium salts and peroxides. Preferred additional free-radical initiators that are light activated are those that have an absorption maximum in the 300 to 400 nm region of the electromagnetic spectrum. Illustrative thereof are 2,2-dimethoxyacetophenone; 2,2-dimethoxy-2-phenylacetophenone; 2,2-diethoxyacetophenone; 2,2-dibutoxyacetophenone, 2,2-dihexoxyacetophenone; 2,2-di(2-ethylhexoxy)acetophenone; 2,2-diphenoxyacetophenone; 2,2-ditolyloxyacetophenone; 2,2-di(chlorophenyl)acetophenone; 2,2-di(nitrophenyl)acetophenone; 2,2-diphenoxy-2-phenylacetophenone; 2,2-dimethoxy-2-methylacetophenone; 2,2-dipropoxy-2-hexylacetophenone; 2,2-diphenoxy-2-ethylacetophenone; 2,2-dimethoxy-2-cyclopentylacetophenone; 2,2-di(2-ethylhexyl)-2-cyclopentylacetophenone; 2,2-diphenoxy-2-cyclopentyl-acetophenone; 2,2-di(nitrophenoxy)-2-cyclohexylacetophenone; 2,2-dimethyl-2-hydroxyacetophenone; 2,2-diethoxy-2- phenylacetophenone; 2,2-diphenethyl oxy-2-phenylacetophenone; 2,2-(2-butenediyloxy)-2phenylacetophenone; 2,2-dimethyl-2-morpholino-(p-thiomethyl)acetophenone; 1-hydroxycyclohexyl phenyl ketone. For the EB version of this technology, however, no photoinitiator is needed to cure the coating.

Several additive components commonly used in coatings may be optionally added. One example is polydimethyl siloxane polymer, a silicone additive used to impart flow and leveling characteristics and surface slip in a UV curable coating. Another component is an optical brightener to improve the color of the composition. These additives may also include surfactants, dispersants, and coalescents.

The acrylated oligomer in a UV formulation is a base resin that is added to the acrylate monomers. These resins are considered the backbone of a UV formulation. Gloss, scuff resistance, chemical resistance, cure speed, block resistance, shrinkage, etc., are all dependent to some degree on the selection of the base resin. This resin could be an epoxy, urethane, polyester or could be another family of resins. Some of these materials which are commonly used and are commercially available are:

Acrylated and methacrylated aliphatic and aromatic epoxy, epoxidized soy bean oil acrylate, epoxy novolac acrylate, di-, tri-, tetra-, hexa-, and multi-functional aromatic and aliphatic urethane acrylate, polyester acrylate, acrylic and acrylated acrylic, chlorinated and acid modified polyester acrylates.

Polymer emulsions and dispersions are key ingredients in the presently preferred embodiments. One type of dispersion emulsion is a reactive acrylic emulsion that can be cured with UV light in the presence of a photoinitiator. An example of this type of emulsion is Roshield 3120 (from Rohn & Haas) which is 40% solids by weight and the remaining 60% is water; Roshield 3188 (UV curable acrylic), BT 44 (thermal drying acrylic), and 98-283 (urethane acrylate). Another example is a reactive epoxy acrylic copolymer dispersion LUX LV 15561 commercially available from Alberdingk Boley, Inc. These reactive emulsions/dispersions can also be cured with EB beam and no photoinitiator is needed in that case.

These reactive emulsions/dispersions are generally based on polymers and copolymers of acrylics, polyesters, polyurethanes, acrylic acid esters, epoxies, etc. Other type of polymers which are available in aqueous dispersion, emulsion, or solution may be based upon the following monomers and/or polymers. They may include copolymers terpolymers and other combinations of these monomers. The polymers may contain active sites such as carboxyl, hydroxyl, unsaturation, amine, epoxy, and others. The colloidal system may be anionic, cationic, or nonionic. This list is exemplary only and is not intended to exclude other monomers: Acetals, Acrylics and Derivatives, Acrylonitrile, Alkyd, Butadiene, Butylene, Cellulosics (including esters, aliphatic derivatives, and other derivatives), Polycarbonates, Halogenated polyolefins, Epoxy, Ethylene, Ethylene Vinyl Acetate, Fluorocarbons, Ionomers, Isobutylene, Isoprene, Olefins, Polyamides, Polyimides, Polyesters, Polyethers, Propylene, Pyrollidones, Silicone, Styrene, Polyurethane, Urea, Vinyl (including chlorides, acetates, esters, alcohols, etc.)

All the ingredients can be added in any sequence except for the polymer emulsion, which should preferably be added at the end with constant mixing. The completed composition is a one-part system and does not require any addition of another material before use. The product requires mixing with a mechanical mixer for about 15 minutes. All these coatings have a shelf life of six months.

UV curable raw materials are traditionally non-volatile. This is the reason UV coatings are gaining market share because they do not pollute the atmosphere. These polymer emulsions contain about 50% to 60% water which will evaporate during the coating/drying process. During the curing of the UV coatings, the water in the systems evaporates. This is different than previous uses of emulsion in UV coatings, such as for coating wood products. In these wood coatings, the water is evaporated in a thermal dryer and the uncured coating can be inspected or recoated. The current invention cures the coating composition with the water still in the coating. It is the presence of the water/polymer emulsion that imparts the high gloss and holdout, and yields the controlled COF and gluability.

When exposed to UV light, the photoinitiator starts the cross-linking reaction and all the reactive ingredients present in the formulation react with each other to form a three dimensional network. The water of the emulsion is then squeezed from the resulting polymer and is evaporated or absorbed by the sustrate. The final product formulation is dependent upon curing.

The following are non-limiting representative examples of compositions included within the present invention.

### EXAMPLE 1

Example 1 contains two types of monomer.

| Component | Wt. % |
|---|---|
| difunctional acrylate monomer | 20-30 |
| trifunctional acrylate monomer | 20-30 |
| benzophenone | 5-10 |
| amine functional acrylate additive | 10-15 |
| ketone photoinitiator | 1-10 |
| polydimethyl siloxane polymer | 0.5 to 5.0 |
| acrylated epoxy monomer blend | 40.0-50.0 |
| aqueous acrylic polymer emulsion | up to 60.0 |

### EXAMPLE 2

Example 2 contains one or more type of monomer in an amount up to 60%. An aqueous acrylic polymer emulsion is included in an amount of up to 20%.

| Component | Wt. % |
|---|---|
| difunctional and/or trifunctional acrylate monomer | 20-60 |
| benzophenone | 5-10 |
| amine functional acrylate additive | 10-15 |
| ketone photoinitiator | 1-10 |
| acrylated oligomer | 20.0-50.0 |
| aqueous acrylic polymer emulsion | up to 20.0 |

### EXAMPLE 3

| Component | Wt. % |
|---|---|
| Difunctional acrylate monomer | 12-30 |
| Trifunctional acrylate monomer | 10-30 |
| Benzophenone | 5-10 |
| Amine functional acrylate additive | 5-15 |
| Ketone photoinitiator | 1-10 |
| Polydimethyl siloxane polymer | 0.5-5.0 |
| Acrylated epoxy monomer blend | 20-50 |
| Aqueous styrenated acrylic polymer emulsion | 1.0 to 60.0 |

### EXAMPLE 4

| Component | Wt. % |
|---|---|
| Difunctional acrylate monomer | 10-30 |
| Trifunctional acrylate monomer | 10-30 |
| Polydimethyl siloxane polymer | 0.5-5.0 |
| Acrylated epoxy monomer blend | 20-50 |
| Aqueous Acrylic polymer emulsion | 1.0 to 60.0 |

### EXAMPLE 5

| Component | Wt. % |
|---|---|
| Difunctional acrylate monomer | 8-22 |
| Trifunctional acrylate monomer | 10-22 |
| Benzophenone | 5-10 |
| Amine functional acrylate additive | 5-15 |
| Ketone photoinitiator | 1-5 |
| Polydimethyl siloxane | 0.5-5.0 |
| Acrylated epoxy polymer | 15-50 |
| Aqueous Polyurethane dispersion | 1.0-60.0 |

The following tables provide a series of presently preferred examples of the present invention. All compositions shown are in weight percent (wt. %).

TABLE 1
(UV Curable Coatings)

| | 1* | 2 | 3 | 4 | 5 | 6 | 7 |
|---|---|---|---|---|---|---|---|
| Tripopylene glycol diacrylate | 25 | 20 | 20 | 20 | 20 | 25 | 25 |
| Trimethylol Propane Triacrylate | 25 | 25 | 20 | 25 | 20 | 25 | 25 |
| Acrylated epoxy; Photomer 3016 | 31 | 31 | 31 | 31 | 31 | | |
| Acrylated polyester, Laromer PE 44F (BASF) | | | | | | 31 | 27 |
| Benzophenone | 7 | 7 | 7 | 7 | 7 | 7 | 7 |
| Amine functional acrylate, Photomer 4967 | 10 | 10 | 10 | 10 | 10 | 10 | 10 |
| Ketone photoinitiator, Darocur 1173 (Ciba) | 1 | 1 | 1 | 1 | 1 | 1 | 1 |
| Polydimethyl siloxane polymer, DC-57 (Dow Corning) | 1 | 1 | 1 | 1 | 1 | | |
| Roshield 3120 (Rohm & Haas) | | 5 | 10 | | | 1 | 5 |
| Aqueous UV reactive acrylic emulsion | | | | | | | |
| Joncryl 74 (S.C. Johnson) | | | | 5 | 10 | | |
| Aqueous UV non-reactive acrylic emulsion | | | | | | | |
| | 100 | 100 | 100 | 100 | 100 | 100 | 100 |

*represents the prior art.

In Table 1, Example 1 is a conventional UV coating of the prior art, which does not include an aqueous emulsion. Example 2 is a UV coating with good holdout on porous paper/board stock. It is also recommended for in-line finishing of conventional lithographic inks with minimal gloss back. Example 3 is a UV coating with excellent holdout on porous paper/board stock as compared to 2 because of greater amount of reactive aqueous emulsion/dispersion. Higher than 10% emulsion/dispersion will cause machining problems. It is also recommended for in-line finishing of conventional lithographic inks. Gloss back may even be lower than Example 2. Example 4 is a UV coating with holdout comparable to 3 but gloss lower than 3 because of the non-reactive nature of aqueous emulsion.

In Table 1, Example 5 is a UV coating with holdout comparable to 3 but gloss lower than 3 because of the non-reactive nature of aqueous emulsion. Higher than 10% of aqueous emulsion results in machining problems. Example 6 has a more consistent COF than conventional coatings. Example 7 has an even more consistent COF than 6. Higher than 5% of aqueous emulsion leads to clinging and blocking and also difficult to achieve higher COF.

TABLE 2
(UV Curable Coatings)

| | 8 | 9 | 10 | 11 | 12 | 13 |
|---|---|---|---|---|---|---|
| Tripopylene glycol diacrylate | 20 | 20 | 25 | 25 | 20 | 20 |
| Trimethylol Propane Triacrylate | 25 | 20 | 25 | 25 | 25 20 | |
| Acrylated epoxy: Photomer 3016 | | | | | | |
| Acrylated polyester, Laromer PE 44F (BASF) | 32 | 32 | 31 | 27 | 32 | 32 |
| Benzophenone | 7 | 7 | 7 | 7 | 7 | 7 |
| Amine functional acrylate, Photomer 4967 | 10 | 10 | 10 | 10 | 10 | 10 |
| Ketone photoinitiator, Darocur 1173 (Ciba) | 1 | 1 | 1 | 1 | 1 | 1 |
| Polydimethyl siloxane polymer, DC-57 (Dow Corning) | | | | | | |
| Roshield 3120 (Rohm & Haas) | 5 | 10 | | | | |
| Aqueous UV reactive acrylic emulsion | | | | | | |
| Joncryl 74 (S.C. Johnson) | | | 1 | 5 | 5 | 10 |
| Aqueous UV non-reactive acrylic emulsion | | | | | | |
| | 100 | 100 | 100 | 100 | 100 | 100 |

In Table 2, Example 8 is a UV coating with good gluability. Example 9 is a UV coating with even better gluability than 1 and 8 because of greater amount of the aqueous emulsion/dispersion. Example 10 has a more consistent COF than conventional, comparable to 6 but lower gloss than 6 because of non-reactive nature of aqueous emulsion/dispersion. Example 11 has an even more consistent COF than 10 but lower gloss than 6 and 10 due to non-reactive nature of the aqueous emulsion/dispersion. Example 12 has gluability close to 8 but lower gloss due to non-reactive nature of aqueous emulsion/dispersion. Example 13 has gluability close to 9 but even lower gloss than 12 due to higher concentration of non-reactive aqueous emulsion/dispersion.

As previously mentioned, other acrylated epoxies from Cognis, such as Photomer 3005, Photomer 3015, Photomer 4028, and the like, can be used instead of Photomer 3016. Also acrylated epoxies are available from several vendors, such as UCB Radcure (Ebecryl 3700, 3701, etc.), Sartomer (CN104, CN112, etc.)and/or BASF (EA81, LR8713, etc.). The present invention is not limited to epoxy acrylate as similar properties can be achieved using acrylated polyesters or acrylated urethanes, and the like. Also, as previously mentioned, oligomers other than Laromer PE 44F can be used to achieve similar properties including acrylated epoxies, acrylated urethanes, etc., which are available from several different vendors. Other acrylated amines, such as Photomer 4770, Ebecryl P115, etc., can be used instead of Photomer 4967. These alternatives apply to the EB Curable Coatings shown below in Tables 3 and 4 as well.

TABLE 3
(EB Curable Coatings)

| | 1* | 2 | 3 | 4 | 5 | 6 |
|---|---|---|---|---|---|---|
| Tripropylene glycol diacrylate | 31 | 31 | 26 | 31 | 26 | 32 |
| Trimethylol proopane triacrylate | 31 | 31 | 31 | 31 | 31 | 35 |
| Acrylated epoxy, Photomer 3016 | 37 | 32 | 32 | 32 | 32 | |
| Acrylated polyester, Laromer PE 44F (BASF) | | | | | | 33 |
| Polydimethyl siloxane polymer, DC 57 (Dow Corning) | 1 | 1 | 1 | 1 | 1 | |
| Aqueous UV reactive acrylic emulsion | | 5 | 10 | | | 1 |
| Roshield 3120 (Rohm & Haas) | | | | | | |
| Joncryl 74 (S.C. Johnson) | | | | 5 | 10 | |
| Aqueous UV non-reactive acrylic emulsion | | | | | | |
| | 100 | 100 | 100 | 100 | 100 | 100 |

*represents the prior art

In Table 3, Example 1 is a conventional EB coating of the prior art, which does not include aqueous emulsion. Example 2 is an EB coating with good holdout on porous stock. It is also recommended for in-line finishing of conventional lithographic inks with minimal gloss back. Example 3 is an EB coating with excellent holdout on porous stock; better than 2. It is also recommended for in-line finishing of conventional lithographic inks as it has higher amount of reactive aqueous emulsion. Higher than 10% of aqueous emulsion results in machining problems. Example 4 is an EB coating with holdout similar to 2 but gloss lower than 2, as the aqueous emulsion is non-UV reactive resulting in lower gloss. Also can be recommended for in-line finishing over conventional lithographic inks if gloss is not too low. Example 5 is an EB coating with holdout similar to 3 on porous stock but gloss lower than 3 because of non-reactive nature of aqueous emulsion. High than 10% of aqueous emulsion/dispersion results in machining problems. Example 6 is an EB coating with more consistent COF than conventional non-skid coatings.

TABLE 4
(EB Curable Coatings)

| | 7 | 8 | 9 | 10 | 11 | 12 | 13 |
|---|---|---|---|---|---|---|---|
| Tripropylene glycol diacrylate | 32 | 31 | 30 | 32 | 32 | 31 | 30 |
| Trimethylol proopane triacrylate | 31 | 32 | 30 | 35 | 31 | 32 | 30 |
| Acrylated epoxy, Photomer 3016 | | | | | | | |
| Acrylated polyester, Laromer PE 44F (BASF) | 33 | 32 | 30 | 32 | 32 | 32 | 30 |
| Polydimethyl siloxane polymer, DC 57 (Dow Corning) | | | | | | | |
| Aqueous UV reactive acrylic emulsion | 5 | 5 | 10 | | | | |
| Roshield 3120 (Rohm & Haas) | | | | | | | |
| Joncryl 74 (S.C. Johnson) | 1 | 5 | 5 | 10 | | | |
| Aqueous UV non-reactive acrylic emulsion | | | | | | | |
| | 100 | 100 | 100 | 100 | 100 | 100 | 100 |

In Table 4, Example 7 is an EB coating with even higher consistency of COF due to higher amount of reactive aqueous emulsion/dispersion. Example 8 is an EB coating with good gluability. Example 9 is an EB coating with even better gluability, better than 1 and 8 because of greater amount of the aqueous emulsion/dispersion. Example 10 is an EB coating with more consistent COF than conventional non-skid coating but lower nature of the aqueous emulsion/dispersion. Example 11 is an EB coating with even more consistent COF than 10 but lower gloss than 10 due to higher concentration of the non-reactive aqueous emulsion/dispersion. Example 12 is an EB coating with better gluability compared to the standard EB coating 1. Its gluability is comparable to 8 but gloss may be lower due to non-reactive aqueous emulsion/dispersion. Example 13 is an EB coating with even better gluability than 12 but gloss could be lower because of the higher concentration of non-reactive aqueous emulsion.

What is claimed is:

1. A radiation curable coating composition, comprising:
(a) at least one reactive monomer in an amount of 1 to 80 wt. %;
(b) a reactive oligomeric resin in an amount of 1 to 15 wt. %; and,
(c) an aqueous polymer emulsion in an amount range of 1 to 50 wt. %

2. The coating composition of claim 1, wherein said reactive monomer is a blend of monomers.

3. The coating composition of claim 1, wherein said reactive oligomeric resin is a blend of resins.

4. The coating composition of claim 1, wherein said composition includes additives for wetting, flow, leveling and optical brightening.

5. The coating composition of claim 1, wherein said composition includes a surface curing photoinitiator in an amount of 1% to 15% wt.

6. The coating composition of claim 1, wherein said composition includes a through-cure photoinitiator in an amount of 1% to 15% wt.

7. The coating composition of claim 1, wherein said composition includes an amine synergist in an amount of 2% to 30% wt.

8. The coating composition of claim 1, wherein said composition includes a visible light curing photoinitiator.

9. A radiation curable coating composition, consisting essentially of (in wt. %):
(a) at least one reactive monomer in an amount of 40 to 80 wt. %;
(b) up to 35 wt. % of at least one reactive oligomeric resin; said monomer and said oligomeric resin together comprising up to about 80 wt. % of said composition;
(c) a surface curing photoinitiator in amount of 5 to 10 wt. %;
(d) an amine synergist in an amount of 5 to 15 wt. %;
(e) a ketone photoinitiator in an amount of at least 1 wt. %; and,
(f) an aqueous polymer emulsion in an amount of at least 1% wt.

10. The radiation curable coating of claim 9, wherein said reactive monomer includes a difunctional acrylate monomer in an amount of 20 to 25 wt. % and a trifunctional acrylate monomer in an amount of 20 to 25 wt. %.

11. The radiation curable coating of claim 9, wherein said oligomer is in an amount of 25 to 35 wt. %.

12. The radiation curable coating of claim 9, wherein said surface curing photoinitiator is in an amount of about 7 wt. %.

13. The radiation curable coating of claim 9, wherein said amine synergist is in an amount of about 10 wt. %.

14. The radiation curable coating of claim 9, wherein said ketone photoinitiator is in an amount of about 1 wt. %.

15. The radiation curable coating of claim 9, wherein said composition includes siloxane polymer in an amount of about 1 wt. %.

16. The radiation curable coating of claim 9, wherein said aqueous polymer emulsion is in an amount of 5 to 10 wt. %.

17. A radiation curable coating composition, consisting essentially of (in wt. %):
(a) difunctional acrylate monomer in an amount of 20 to 25 wt. % and a trifunctional acrylate monomer in an amount of 20 to 25 wt. %, and up to about 31 wt. % of other reactive monomer;
(b) reactive oligomeric resin in an amount of about 27 to 32 wt. %, said monomer and said oligomeric resin together comprising up to about 80 wt. % of said composition;
(c) a surface curing photoinitiator in an amount of about 7 wt. %;
(d) an amine synergist in an amount of about 10 wt. %;
(e) a ketone photoinitiator in an amount of about 1 wt. %; and,
(f) an aqueous polymer emulsion in an amount of at least 1 wt. %.

18. The radiation curable coating of claim 17, wherein said aqueous polymer emulsion is in an amount of about 5 wt. %.

19. The radiation curable coating of claim 17, wherein said aqueous polymer emulsion is in an amount of about 10 wt. %.
